(19) United States
(12) Patent Application Publication
(10) Pub. No.: US 2026/0205888 A1
(43) Pub. Date: Jul. 16, 2026

(54) METHODS AND APPARATUS FOR ENABLING RELIABLE AND AVAILABLE WIRELESS COMMUNICATIONS FOR MULTIMODAL APPLICATIONS

(71) Applicant: InterDigital Patent Holdings, Inc., Wilmington, DE (US)

(72) Inventors: Carlos Jesus BERNARDOS, Madrid (ES); Magurawalage Chathura Madhusanka SARATHCHANDRA, London (GB); Alain MOURAD, Ascot (GB); Michael STARSINIC, Newtown, PA (US); Xavier DE FOY, Kirkland (CA)

(73) Assignee: InterDigital Patent Holdings, Inc., Wilmington, DE (US)

(21) Appl. No.: 19/133,883

(22) PCT Filed: Dec. 15, 2023
(86) PCT No.: PCT/US2023/084364

§ 371 Date: May 29, 2025

Related U.S. Application Data
(60) Provisional application No. 63/433,153, filed on Dec. 16, 2022.

(51) Int. Cl. H04W 28/24; H04W 8/22; H04W 76/14; H04W 76/15

(52) U.S. Cl. CPC H04W 28/24; H04W 8/22; H04W 76/14; H04W 76/15

(57) ABSTRACT

A multimodal application is an application that may include several modalities of communication such as audio, video and haptics. Accordingly, a multimodal application may be decomposed into multiple smaller components, and the multiple components may be distributed in the network and run separately on collaborative devices, which may use multiple flows to transfer multimodal traffic. Deterministic Networks (DetNet) defines capabilities that enable collaborative devices to support multimodal traffic by enabling each device to consider all available paths when selecting a path to transfer data. The network may instantiate different application components in different devices and configure each device with traffic policies aligned with DetNet policies. This process may be enabled by extensions to ProSe capabilities and to traffic policies based on DetNet capabilities and policies with the objective of guaranteeing a given QoS in terms of latency, reliability and availability.

### CROSS-REFERENCE TO RELATED APPLICATIONS

This application claims the benefit of U.S. Provisional Application No. 63/433,153, filed Dec. 16, 2022 the contents of which are incorporated herein by reference.

### BACKGROUND

Deterministic Networking (DetNet) is an effort led by the Internet Engineering Task Force (IETF) DetNet Working Group (WG) that studies implementation of deterministic data paths for real-time applications. Real-time applications require bounded latency and extremely low data loss rates and low jitter. Examples of such applications include audio and video streaming, engine control systems, and industrial and vehicular automation. DetNet operates at the IP layer and delivers service over lower-layer technologies such as Multi-Protocol label Switching (MPLS) and IEEE 802.1 Time-Sensitive Networking (TSN). DetNet provides a reliable and available service by dedicating network resources such as link bandwidth and buffer space to DetNet flows and/or classes of flows, and by redistributing and/or replicating data packets along multiple paths. Multimodal applications may include multiple modalities of communications, such as audio, video, and haptics. A multimodal application may be decomposed into multiple smaller functions, and the multiple smaller functions may be distributed in the network to run on collaborative devices (e.g., WTRUs, UEs) and/or infrastructure nodes. Since the applications often require strict and reliable behavior, it is key to provide procedures that enable the collaborative devices and infrastructure nodes to achieve the required performance.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 show shows a DetNet data plane protocol stack;

FIG. 3 show an example of communication involving multiple collaborative devices and different locations at the infrastructure;

FIG. 4 shows an example authorization procedure for 5G ProSe and DetNet communication;

FIG. 5 shows a high level view of an example of a multimodal sidelink operation; and

FIG. 6 shows an example procedure of multimodal sidelink operation.

### DETAILED DESCRIPTION

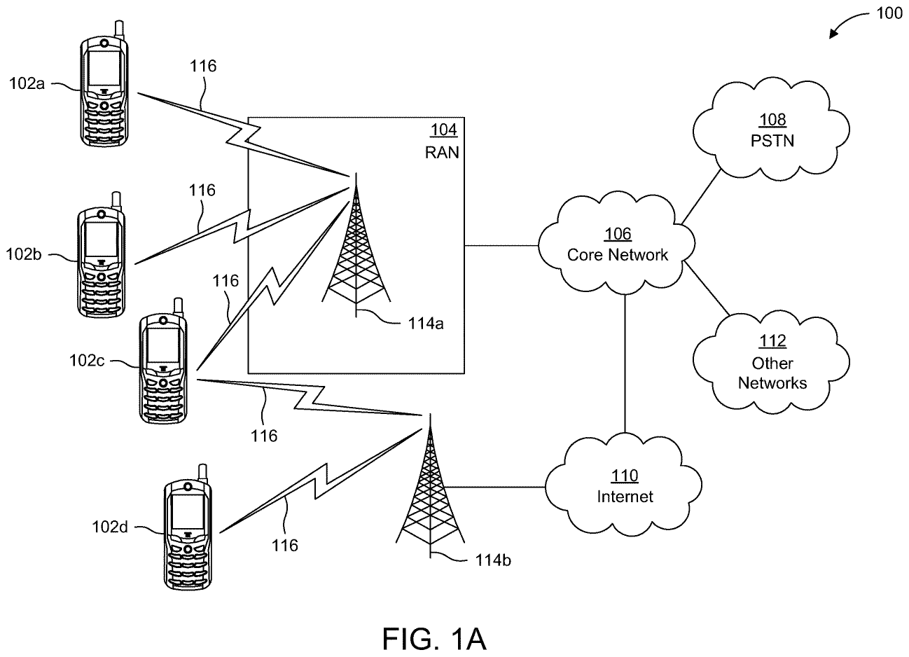

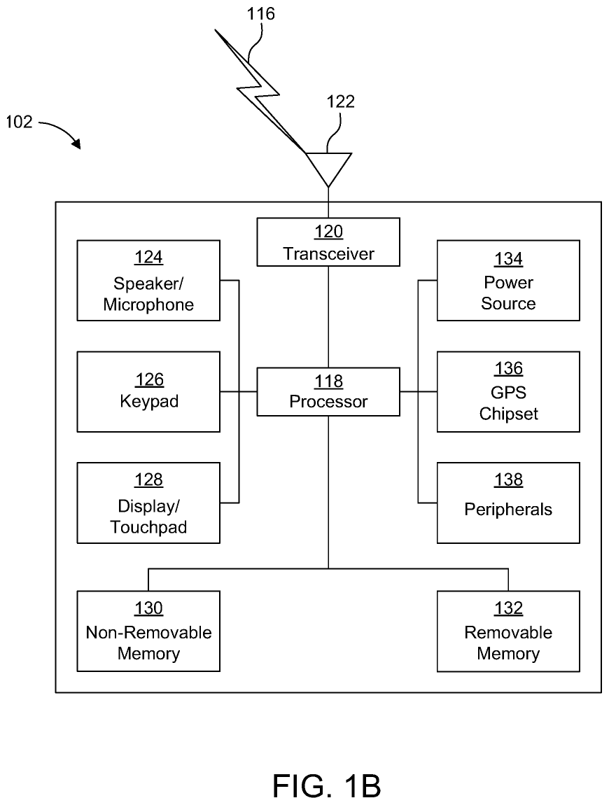

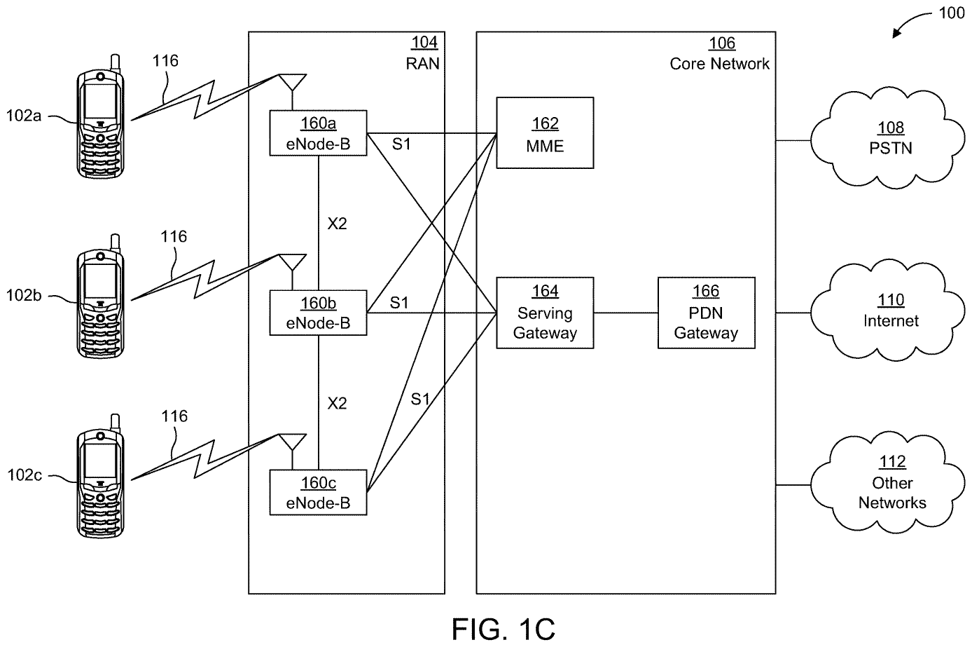

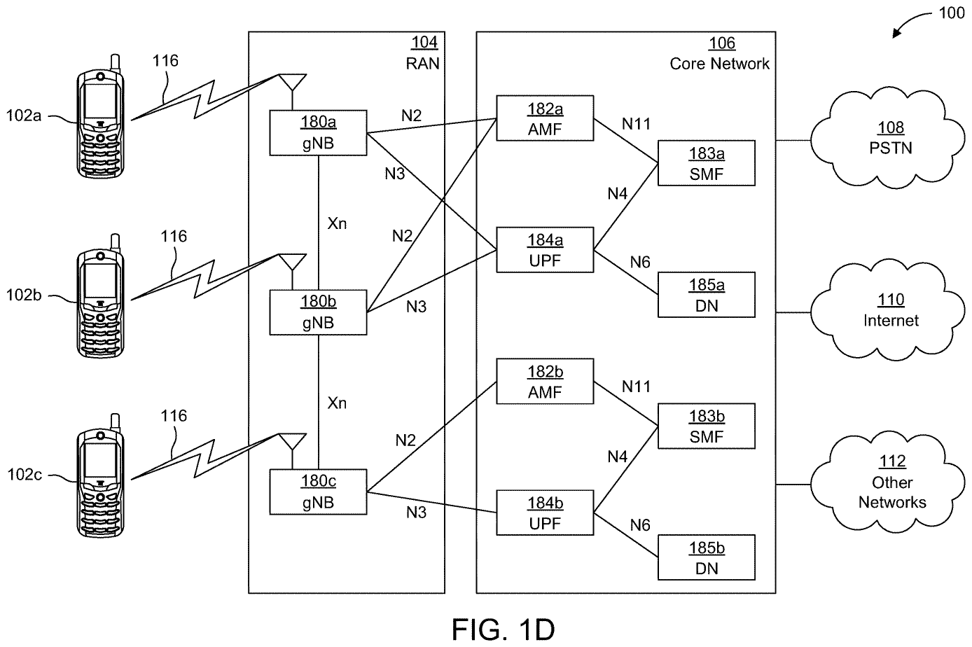

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Abbreviations and Acronyms

5GC 5G Core
BSS Business Support System
D2D Device-to-Device
DetNet Deterministic Networking
IETF Internet Engineering Task Force
IIoT Industrial Internet of Things
LDACS L-band Digital Aeronautical Communications System (LDACS)
OAM Operations, Administration and Maintenance
OODA Observe, Orient, Decide, Act
OSS Operation Support System
PAREO Packet (hybrid) ARQ, Replication, Elimination and Ordering
PCE Path Computation Element
PDU Packet Data Unit
PEF Packet Elimination Function
POF Packet Ordering Function
PREOF Packet Replication, Elimination, and Ordering Functions
PRF Packet Replication Function
ProSe Proximity Services
PSE Path Selection Engine
QoS Quality of Service
RAW Reliable and Available Wireless
SL SideLink
SLA Service Level Agreement
TSCH Time Slotted Channel Hopping
URLLC Ultra-Reliable Low Latency Communications
V2X Vehicular to Everything
WTRU Wireless Receive-Transmit Unit
XR Extended Reality
WG Working Group

### Definitions

Deterministic Networking (DetNet): IETF WG responsible for the definition of data and control plane procedures to support deterministic networking in wired and wireless multi-hop networks.
Reliable and Available Wireless (RAW): Extension of IETF DetNet with the objective of guaranteeing high reliability and availability for an IP network utilizing scheduled wireless segments.
DetNet service sub-layer: Sub-layer providing DetNet services to higher layers in the protocol stack and to applications.
DetNet forwarding sub-layer: Sub-layer supporting DetNet service to the underlying network. Packet Replication, Elimination, and Ordering Functions (PREOF): Functions of the DetNet service sub-layer. It comprises:
   1. Packet Replication Function (PRF): Replicates packets
   2. Packet Elimination Function (PEF): Eliminates duplicate packets
   3. Packet Ordering Function (POF): Reorders packets in DetNet flows
Path Computation Element (PCE): Generates alternative solutions for packet forwarding
Path Selection Engine (PSE): Selects one of the solutions defined by PCE to be used for each packet
OODA (Observe, Orient, Decide, Act) loop: Phases performed during DetNet operation.
   1. Observe phase: Monitoring some or all hops along a Track
   2. Orient phase: Reporting links statistics to PCE
   3. Decide phase: PSE decides which Sub-Track to use for the next packet(s) that are routed along the Track.
   4. Act phase: PAREO data plane actions operate at the DetNet service layer to increase the reliability of the end-to-end transmission.
DetNet Path: Route through the network designed to meet certain performance guarantees, such as low latency, bounded jitter, and high reliability. Paths are established to ensure predictable and consistent network behavior.
DetNet Track: Network resources reserved for a specific DetNet Path. Tracks are established to isolate traffic in a DetNet Path from other network traffic.

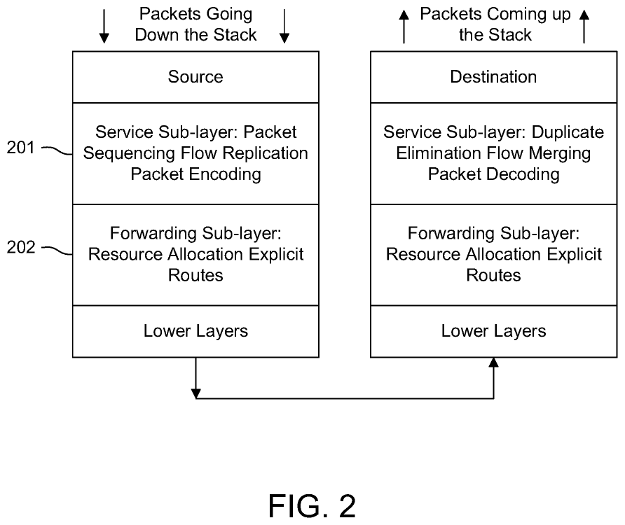

FIG. 2 shows a DetNet data plane protocol stack. The DetNet functionality is implemented in two adjacent sub-layers in the protocol stack. The DetNet service sub-layer 201 and the DetNet forwarding sub-layer 202. The DetNet service sub-layer 201 provides DetNet service, for example service protection, to higher layers in the protocol stack and applications. The DetNet forwarding sub-layer 202 supports DetNet service in the underlying network, for example by providing explicit routes and resource allocation to DetNet flows.

The DetNet service sub-layer includes the Packet Replication Function (PRF), Packet Elimination Function (PEF), and Packet Ordering Function (POF) for use in DetNet edge, relay node, and end-system packet processing. These functions may be enabled in a DetNet edge node, relay node, or end system. The collective name for all three functions is Packet Replication, Elimination, and Ordering Functions (PREOF). The packet replication and elimination service protection method altogether involves four capabilities. Sequencing information is provided to the packets of a DetNet compound flow. This may be done by adding a sequence number or time stamp as part of DetNet, or it may be inherent in the packet, for example in a higher-layer protocol or associated to other physical properties such as the precise time (and radio channel) of reception of the packet. This is typically done once, at or near the source. The PRF replicates these packets into multiple DetNet member flows and typically sends them along multiple different paths to the destination(s). The PEF eliminates duplicate packets of a DetNet flow based on the sequencing information and a history of received packets. The output of the PEF is a single packet. This may be done at any DetNet node along the path to save network resources further downstream, in particular if multiple replication points exist. The most common case is to perform this operation at the very edge of the DetNet network, preferably in or near the receiver. The POF uses the sequencing information to reorder a DetNet flow's packets that are received out of order.

In order to perform PREOF, the DetNet service layer requires the user data plane between DetNet nodes to include sequencing information and a service label, called S-label. Based on time, resource reservation, and policy enforcement by distributed shapers, DetNet aims to provide the capability to carry specified unicast or multicast data streams for real-time applications with extremely low data loss rates and bounded latency, so as to support time-sensitive and mission-critical applications on a converged enterprise infrastructure. Wireless systems operating on a shared medium may experience unpredictable behavior due to the inherent volatile nature of wireless communications. Accordingly, the wireless medium may present significant challenges to achieve deterministic properties such as very low packet error rate, bounded consecutive losses, and bounded latency.

Reliable and Available Wireless (RAW) refers to the extension of IETF DetNet concepts with the objective of guaranteeing high reliability and availability for an IP network utilizing scheduled wireless segments and other functionality, for example frequency/time-sharing physical media resources with stochastic traffic such as IEEE Std. 802.15.4 Time Slotted Channel Hopping (TSCH); 3GPP features targeting 5G Ultra-Reliable Low Latency Communications (URLLC); IEEE 802.11ax/be; and L-band Digital Aeronautical Communications System (LDACS). Similar to DetNet, RAW technologies aim at staying abstract to the radio layers underneath, addressing the Layer 3 aspects in support of applications requiring high reliability and availability. The term DetNet is used herein to refer to IETF DetNet technologies, including its extension to RAW.

The DetNet architecture framework summarizes the main DetNet operation as follows: DetNet distinguishes between long and short forwarding time scales: long time scale is used for routes computation and short time scale is used for packet-per-packet forwarding decisions. DetNet operates within the network plane at the forwarding (short) time scale on one DetNet flow over a complex path called a “Track”. A Track represents the network resources reserved along a path which are dedicated to DetNet traffic. Tracks are established to isolate traffic in a DetNet path from other network traffic with the objective of guaranteeing certain QoS requirements such as low latency, bounded jitter, and high reliability. The Track is pre-established and installed by means outside of the scope of DetNet and it may be strict or loose depending on whether each or just a subset of the hops are observed and controlled by DetNet. A Sub-Track is a “Track within a Track”.

The DetNet architecture is structured as an OODA (Observe, Orient, Decide, Act) loop. The OODA loop represents the operational phases in a control loop. The DetNet architecture applies this model to continuously optimize the spectrum and energy used to forward packets within a recovery graph by instantiating the OODA phases: Observe, Orient, Decide, and Act.

The path computation time scale, which is the time scale at which a complex path is (re)computed; and the path selection time scale, which is the time scale at which the forwarding decision is taken for one or a few packets. The DetNet function is to perform path selection on a packet-by-packet basis, with the objective of providing a reliable and available service, while minimizing the waste of constrained resources. For example, the PCE may generate alternative solutions on routing and through the DetNet loop, one solution is chosen. To that effect, DetNet defines the PSE, a counter-part of the PCE to perform rapid local adjustments of the forwarding tables within the diversity that the PCE has selected for the track. The PSE enables to exploit the richer forwarding capabilities with PAREO, and schedule transmissions at a faster time scale.

In the Observe phase, network plane measurement protocols for Operations, Administration and Maintenance (OAM) monitor some or all hops along a Track, as well as the end-to-end packet delivery. In the Orient phase, controller plane elements report the links statistics to a Path Computation Element (PCE) in a centralized controller that computes and installs the Tracks and provides metadata to orient the routing decision. In the Decide phase, a runtime distributed Path Selection Engine (PSE) decides which Sub-Track to use for the next packet(s) that are routed along the Track. In the Act phase, Packet (hybrid) ARQ, Replication, Elimination and Ordering (PAREO) data plane actions operate at the DetNet service layer to increase the reliability of the end-to-end transmission. The DetNet architecture also addresses piggybacking signaling (i.e., signaling that is sent in data packets) when the decision is acted upon by a node that is on the path down the Track from the PSE. The overall OODA loop optimizes the use of redundancy to achieve the required reliability and availability to maintain the Service Level Agreement (SLA) while minimizing the use of constrained resources, such as spectrum and battery.

Path Computation Element (PCE) generates alternative solutions and one solution is chosen to be used for each packet to provide a reliable and available service, while minimizing the waste of constrained resources. DetNet defines the Path Selection Function (PSE) that is the counter-part of the PCE to perform rapid local adjustments of the forwarding tables within the diversity that the PCE has selected for the Track. The PSE enables to exploit the richer forwarding capabilities with Packet (hybrid) ARQ, Replication, Elimination and Ordering (PAREO), and scheduled transmissions at a faster time scale.

As opposed to the definition of a path above, a “Track” is not necessarily linear. It may contain multiple paths that may fork and rejoin, for example to enable the DetNet PAREO operations. In DetNet terms, a Track has the following properties: a Track has one ingress node and one egress node which operate as DetNet edge nodes; a Track is reversible, meaning that packets may be routed against the flow of data packets (e.g., to carry OAM measurements or control messages back to the Ingress node); the vertices of the Track are DetNet relay nodes that operate at the DetNet service sublayer and provide the PAREO functions; and the topological edges of the graph are serial sequences of DetNet transit nodes that operate at the DetNet Forwarding sublayer. The DetNet PSE selects a Sub-Track on a packet-by-packet basis or on a per-group-of-packets basis to provide the desired reliability for the transported flows.

In 3GPP, 5G NR Sidelink (SL) was introduced in release 16 to enable devices in proximity to directly communicate with each other without packets going through the 3GPP network. Device-to-Device (D2D) direct communication protocols enable two devices to communicate directly between them with or without the aid of the network. Different scenarios exist for D2D communication depending on whether the UEs involved are within or not within the coverage of a cellular network. Targeted applications include mission critical services, Vehicular-to-Everything (V2X) services and Industrial Internet of Things (IIoT). D2D communication promises ultra-low latency links and is therefore an attractive solution for various emerging applications such as AR, VR, and XR.

Within the scope of D2D, two technologies are typically supported in the 3GPP standards: Proximity Services (ProSe) and group communications. ProSe allows devices in proximity to each other to discover each other and to communicate directly with each other. This is enabled by D2D discovery and D2D direct communication procedures. Discovery procedures allow a UE to discover another UE in its proximity, which may be performed directly by a UE or through the network. Group communication procedures allow one-to-many communication among UEs in a highly resource efficient manner, allowing messages to be disseminated easily to a large group of people, over a common stream.

The concept of a Packet Data Unit (PDU) Set was first introduced in 3GPP in the study on XR (Extended Reality) and media services. A PDU Set comprises a set of inter-related PDUs grouped together, allowing them to be treated similarly (e.g., PDUs comprising of data that belong to the same video frame). The definition of a PDU Set, as defined in 3GPP TR 23.700-60 V1.2.0 is: A PDU set is composed of one or more PDUs carrying the payload of one unit of information generated at the application level (e.g., a frame or video slice for XRM services, as used in TR 26.926). In some implementations, all PDUs in a PDU set are needed by the application layer to use the corresponding unit of information. In other implementations, the application layer can still recover parts or all of the information unit even when some PDUs are missing.

There are several use cases where reliability and availability are key requirements for wireless heterogeneous networks. Relevant examples are extended Reality (XR) and multimodal applications, such as for example immersive gaming, digital twinning, etc. In these environments, UEs demand strict and predictable behavior, in terms of latency and/or resilience and/or availability and/or throughput, while they move and might change its point of attachment. As described in previous paragraphs, a multimodal application is an application that may include several modalities of communication such as audio, video and haptics. Accordingly, a multimodal application may be decomposed into multiple smaller functions, and the multiple smaller functions may be distributed in the network to run on collaborative devices (e.g., WTRUs, UEs) and/or infrastructure nodes (e.g., nodes in the edge or the cloud). The communication between the devices and the infrastructure nodes is via multimodal communication links, which may be communication links that can be used by a DetNet enabled flow, i.e., links over which DetNet mechanisms may be enabled.

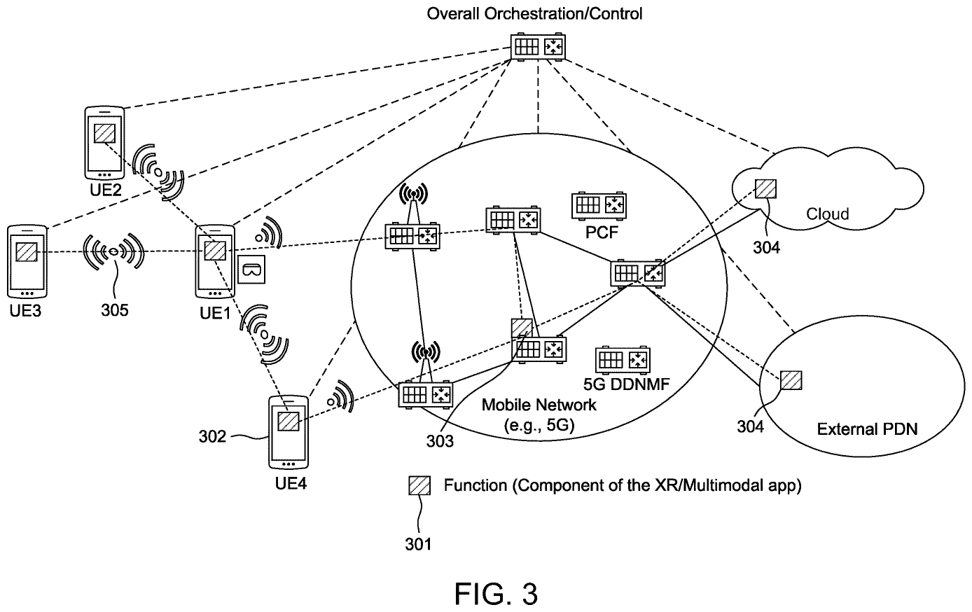

FIG. 3 shows an example of communication involving multiple collaborative devices and different locations at the infrastructure. The devices are called “collaborative” because they collaborate to forward the same or different packets of multimodal flows to a destination. A given application may have multiple functions (or components) 301, each of them running at a different location, both on the terminal 302 and in the infrastructure side 303, 304. UEs make use of device-to-device/sidelink communications 305 to communicate among them. New solutions are needed to allow UEs to decompose applications in different functions that may run on these distributed nodes (including other UEs 302 and infrastructure nodes 303 304, such as the edge/cloud 304) in a way that guarantees the reliability and availability requirements of each of the involved nodes across multiple network segments and transports.

Typically, traffic and QoS requirements are addressed at the session/flow granularity. This limits the capabilities of the system to satisfy the QoS requirements, especially in scenarios where the application requires strict latency requirements and the inherent volatile nature of device-to-device communication entails frequently fluctuating network conditions. The IETF DetNet WG is responsible for the definition of data and control plane procedures to support deterministic networking in wired and wireless multi-hop networks. The DetNet capabilities enable the network to consider all available paths when deciding on the most suitable path to transfer data, considering runtime conditions. It also allows traffic forwarding decisions to be done at the packet level, allowing to make more dynamic changes at a finer granularity.

UEs may collaborate to support distributed multimodal/XR traffic, by providing reliability and availability to multiple flows. Procedures for collaborative UEs to support multimodal traffic may be defined. Extensions to the ProSe signaling, as well as to the UE and ProSe policies, may enable the use of multiple sidelink channels simultaneously to support such applications. Messages may be exchanged among the UEs to enable multiple collaborative UEs to use multiple sidelink channels in a way that guarantees a given QoS in terms of reliability and availability. Various illustrative functional blocks and method phases are described in terms of their functionality or logical blocks. Whether such functionality is implemented as hardware, software, or combinations of both, depends upon the particular application and design constraints imposed on the overall system. The illustrative procedures described for the various embodiments may be described as functions with phases following a certain order, wherein the particular order is for clarity purposes only. Accordingly, for different implementations, some phases may be performed in a different order, some phases may be skipped or may not be present in all embodiments, and some phases may be added (and may not be shown herein). Similarly, the names of parameters, messages and procedures used herein are for clarity purposes only, and may vary in different implementations.

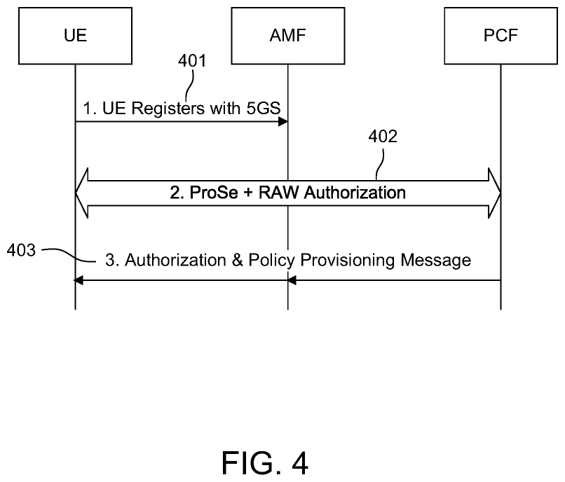

FIG. 4 shows an example of an authorization procedure that may be used by the UE for a combined ProSe and DetNet authorization. In 401, UE(s) that participate in a multimodal/XR application, may register with the 5G system. The UE may indicate multimodal/XR application functionality support and DetNet capabilities in the existing Registration Request message 401. One or more DetNet-specific Information Elements (IEs) may be added to the Registration Request message sent by the UE (see clause 4.2.2.2.2 of 3GPP TS 23.502 V17.3.0 for a typical registration message). Optionally, a new registration message may be defined including one or more IEs with multimodal/XR application functionality support. In another example, a new procedure may be defined for the UE to communicate to the network its multimodal/XR application functionality support and DetNet capabilities. The information sent by the UE to the network related to the multimodal/XR application functionality support may include one or more multimodal/XR applications supported by the UE(s). For example, the DetNet capabilities may be included in the “5GMM Capability” IE in the Registration Request message (as an example, see release 18 of 24.501). The multimodal/XR application functionality support may also indicate the intention of the UE to join an existing group that is already supporting one of such applications, for example via an Application Identity (App ID).

For requesting ProSe policies, UEs use the 5G ProSe Policy Provisioning Request IE in the Registration Request message or during the UE Triggered 5G ProSe Policy Provisioning procedure (as defined in clause 4.3.1 in 3GPP TW 23.304V17.0.0 ). In an embodiment, the 5G ProSe Policy Provisioning Request IE is extended to include new capabilities/parameters for DetNet (e.g. included in the list below) along with existing parameters for 5G ProSe direct discovery, and other ProSe features. The new policy parameters may include: (a) the DetNet capabilities supported by the UE (e.g., indication whether DetNet capabilities are supported, indication whether DetNet enhanced ProSe/sidelink relay capabilities are supported); (b) the DetNet functions hosted by the UE (e.g. PSE function); Packet and PDU set level switching/forwarding/routing capability (e.g. packet-level switching enabled by PSE, allowing to switch paths/tracks/sub-tracks much faster); (d) information related to the multimodal flows (e.g. QoS requirements of each flow, application modality type [audio, video, haptic]) or an Application ID may be used by the network to determine the QoS Requirements for the application layer traffic and to make resource reservation decisions; (e) the duration or when DetNet and ProSe/Sidelink communication links may be required, which may be specified as a duration, or with start/end times, or geographical locations where the DetNet and ProSe/Sidelink services are required.

A new procedure may be defined to exchange DetNet capabilities and policies between UEs and the network or between different UEs. The network may send its DetNet capabilities and the traffic policies to the UE, referred to as DetNet configuration herein. The DetNet configuration may be sent autonomously, i.e., the UE does not request it, and it may be sent e.g., during the UE authorization registration. Optionally, the configuration may be sent to the UE as a response to an explicit request from the UE.

In 402 of FIG. 4, the UE may perform an authorization procedure with network, more specifically with the PCF (e.g., PCF via AMF over the N1 interface). Optionally, the UE may perform an authorization procedure with the ProSe Application Server over the PC1 interface. The UE may send or receive an Authorization message to/from the 5GC (i.e. PCF via AMF over the N1 interface) or through the ProSe Application Server over the PC1 interface. The UE may be pre-configured with ProSe+DetNet configuration, and the 5GS (e.g., PCF) may send the Authorization message with a list of PLMNs/networks/geolocations/cells where the UE may use ProSe discovery and direct communication and the DetNet configuration. In cases where there is no associated UE context, subscription information may be acquired (e.g., through UDM). The UE may send an authorization request to the network, for gaining authorization for using ProSe +DetNet capabilities within the specified PLMNs/networks/geolocations/cells. For example, ProSe+DetNet capabilities may be specified as packet-level path/track/sub-track switching, and availability of locally hosted PSE.

The authorization message may include information related to the time ProSe communication is valid for, as a duration or start and/or end times. The authorization message may comprise information related to the authorization of ProSe discovery and direct communication (e.g., including parameters such as authorization policy and others as described in clause 5.1.3 in 3GPP TS 23.304V17.0.0 ) and related to the authorization of DetNet service (e.g., a list of ProSe identifiers with geographical area that require privacy support, authorized PLMN). The authorization message may be based on an existing service authorization for Prose and include new IEs for enabling the authorization of new DetNet capabilities; optionally existing procedures may be extended to enable the authorization of new DetNet capabilities. Such new capabilities may comprise the following: (i) an indication weather DetNet features are enabled, or alternatively, the UEs/5GC may not include this explicit indication, but may realize authentication for DetNet functions, based on the following parameters; (ii) hosted DetNet functions, which may indicate the DetNet functions (e.g., PSE) that may be hosted by the UE for providing services to other network entities; (iii) path switching capabilities that may indicate whether the UE supports dynamic path/track switching, and if yes, at which level the switching may be performed (e.g., packet, PDU, PDU set); (iv) DetNet domains that are of interest and domain IDs that are of interest to the application, which may allow to restrict domains to only some UEs.

The authorization message may comprise information related to the multimodal flows (e.g., QoS requirements of each flow, application modality type [audio, video, haptic]). Alternatively, the UE may provide an Application ID that is used by the network to determine the QoS requirements for the application layer traffic and to make resource reservation decisions.

The authorization message may comprise authorization information required for the DetNet network operation. This may either use the subscription data, the existing authorization mechanisms of 5GS, or an external authorization system (for cases were some services of DetNet are provided externally). Such information may include, but are not limited to, authorization to host DetNet functions (e.g., PSE), authorization to perform switching at any of packet and PDU levels, authorization to provide DetNet services to other UEs (e.g., acting as a ProSe+DetNet relay UE).

In some scenarios, 402 of FIG. 4 may be triggered by 401. In 403, the UE may receive a configuration message comprising any combination of information specified in 402. In scenarios where only partial information is sent to the UE in 402 the remaining information may be sent through the Authorization and Policy Provisioning message 403, along with authorization for ProSe Discovery, and it may include the following information: (a) authorization for the UE to use ProSe Discovery and Direct Communication; (b) authorization for the UE to use DetNet features, including requesting establishment of flows using DetNet capabilities; applying DetNet service on flows forwarded through the UE; forwarding/routing/switching flows between UEs or between UE and the network; or to use other DetNet features as described herein, and for parts/segments of the DetNet networks (e.g., only some DetNet domains may be authorized to be used, while other domains, which allow lower latency and higher bandwidth, may be accessible only to higher tier subscribers).

In FIG. 4, the procedures pertaining to DetNet PCE may be implemented as an extension to the PCF and/or may be deployed alongside the PCF. The DetNet PSE functionality may be hosted by all or some UEs that are used by the multimodal application.

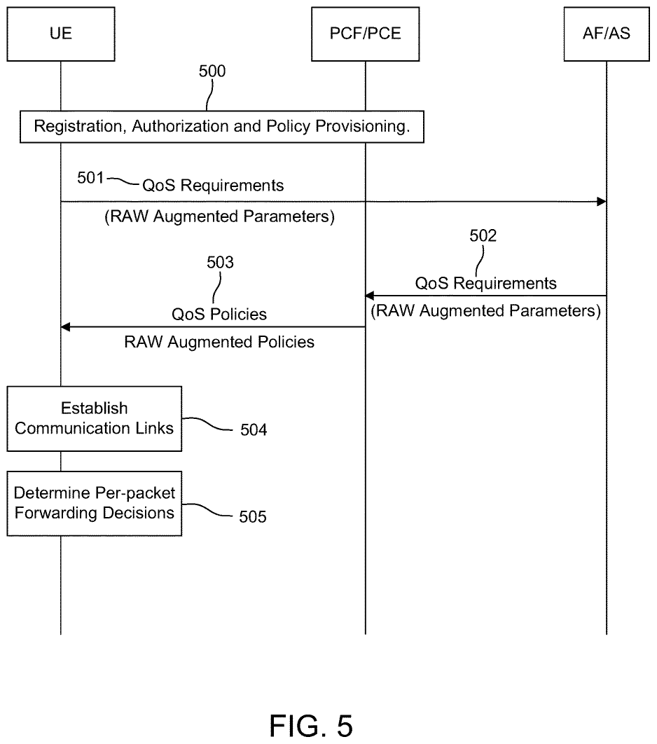

FIG. 5 illustrates a summarized example of a multimodal link establishment procedure. After the registration, authorization and policy negotiation 500, which was described above, a UE may start the establishment procedure. The UE may indicate the QoS application requirements to an AF/AS 501. The QoS requirements may include DetNet-augmented parameters, comprising at least one of bounded latency, reliability, and availability requirements associated with the multimodal application. The latency refers to a one-way, end-to-end latency. The availability refers to the percentage of the total time that a service is available for usage “as intended,” i.e., able to meet the required QoS. Reliability is the percentage of the operating time that the service is operating “as intended,” i.e., meeting the required QoS.

The AF/AS may forward the information to the PCF/PCE 502. The PCF/PCE may perform an update of the UEs QoS policies, including DetNet-augmented policies 503. The UE may establish both ProSe and DetNet communication links needed to satisfy the QoS requirements of the multimodal application 504. The UE may use the QoS policies to perform per-packet forwarding decisions, ensuring the QoS application requirements are met 505.

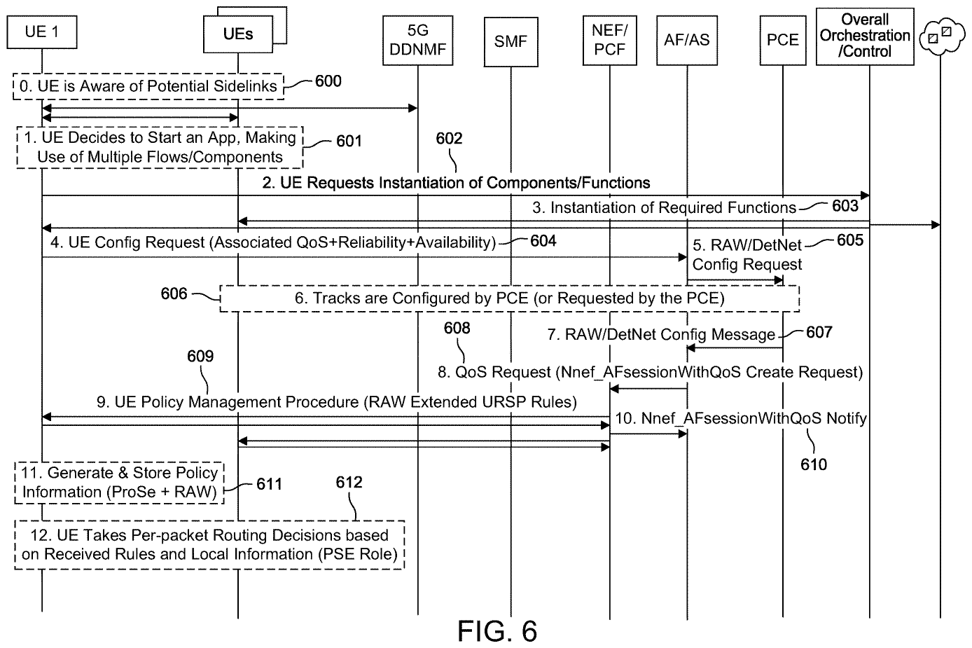

FIG. 6 shows another example procedure for multimodal sidelink operation. A UE (UE 1) may be aware of other UEs in its neighborhood to which sidelink communications may be established and that are capable of instantiating the multiple functions that may be part of a multimodal/XR application 600. Each UE may indicate to the network (e.g., to 5G DDNMF) the DetNet capabilities supported and/or hosted by the UE (e.g., PSE). The 5G DDNMF is the Direct Discovery Name Management Function in the 5G Core Network which handles network actions required for direct discovery procedures.

In a case where ProSe open discovery procedures are used (Model A), all UEs that are capable of instantiating functions of a specific multimodal/XR application send ProSe Discovery announcement messages over a PC5 reference point announcing their capabilities. A ProSe application code/ID may be defined to identify the specific multimodal/XR application, which in turn may be used by UE1 for identifying suitable UEs in the proximity, when monitoring. This message may include an indication of the specific DetNet services supported by each individual UE. In a case where the ProSe restricted discovery procedures are used (Model B), a UE (UE 2) (and all other UEs), may obtain authorization for restricted discovery. UE 1 sends announcement messages over the PC5 interface targeting UEs that are capable of instantiating functions of a multimodal/XR application. The application may be identified by a ProSe application code, that was obtained during authorization, or during another procedure with the network. This message may comprise an indication of the DetNet services supported by each individual UE. The UE may identify which UEs detected support DetNet extensions. UEs that do not support DetNet may be used for transmitting only non-DetNet traffic.

A UE may decide how to split an application in different components/flows and where to instantiate them, considering other UEs and the infrastructure 601. The UE may consider the different computing and connectivity requirements.

A UE, or an Application Function (AF), requests the instantiation of the multiple functions that comprise the service 602. This message may be an application layer message that is sent by a service enabler client in the UE to an AF. Alternatively, this be a part of a PDU Session Establishment or PDU Session Modification procedure, and may include additional DetNet parameters related to the links to be established with the other UEs: (a) packet and PDU set level switching/forwarding/routing capability comprising packet-level switching enabled by PSE, allowing to switch paths/tracks/sub-tracks much faster.); (b) information related to the multimodal flows, including QoS requirements of each flow, application modality type [audio, video, haptic]); and (c) the duration of the communication, or when DetNet and ProSe/Sidelink communication links may be required. The communication link duration may be given as start time and end time or start time and a length of time. The start time may be in reference to another time known to all UEs, such as a frame number, a slot number, or a symbol number. The start time may be in reference to the end time of another procedure, such as discovery procedure. The additional parameters may comprise geographical locations where the DetNet and ProSe/Sidelink services are required.

An orchestrator/controller entity may instantiate the different functions 603. An orchestrator/controller may send messages to service enabler clients that are hosted in other UEs and/or the network infrastructure, including, e.g., the identities of these UEs/infrastructure nodes, which may be known by either the requesting UE or an AF. An example of orchestration framework is the one defined by the ETSI NFV. The orchestrator may handle application components. In some implementations, an orchestrator may be replaced with a control entity in charge of deploying/instantiating the different components (e.g., Operation Support System (OSS), Business Support System (BSS).

A UE may indicate the application requirements in terms of QoS to an AF/AS 604. The QoS policy request may include DetNet-augmented parameters, comprising at least one of bounded latency, reliability, and availability requirements associated with the set of network flows which are associated with the multimodal application. The UE may also indicate the QoS requirements per individual single-modal flow. The UE may provide an application ID that the AF/AS may map to a set of QoS requirements.

The AF/AS may send the received QoS configuration request message to the PCE, which may include information of multimodal flows (e.g., the received QoS requirements) 605. The AF/AS may add additional parameters to the message, which are AS-specific requirements associated with the multimodal flows. The PCE may be hosted as part of PCF or on the same node.

The PCE may trigger the configuration of the network paths that may be used as Tracks, if they are not already configured, and assign them Track IDs 606. The configuration may be done by the appropriate network entity based on a request from the PCE, e.g., PCF, SDN controller. The configuration involves the PCE configuring the network elements, including UEs, required to form the required network links (e.g., QoS profiles, forwarding profiles, etc.) including D2D links (e.g., specifying Prose IDs of peer UEs, etc.).

The PCE may determine or compute the possible paths or Tracks between the different UEs, which may then be used by the UEs to take per-packet forwarding decisions. The PCE may use different pieces of information to compute these Tracks (e.g., monitoring information from OAM tools running in the network, information exposed by the NEF, etc.). The PCE sends a configuration message to the AF/AS 607. The configuration may include the paths being computed per each flow in the multimodal session, including their Track IDs. The configuration may comprise a set of configurations to be used based on the runtime conditions. Each configuration may be associated with a condition vector containing upper and lower bounds for each parameter (e.g., distance/channel quality to a neighboring UE). In scenarios where a subset of DetNet capabilities may be provided by an external network or component (e.g., application layer protocol), the message may comprise the services that the 5GS is responsible of providing and the services DetNet network is responsible of executing. In scenarios where DetNet capabilities are not provided by the 5GS, DetNet capabilities may be offered by a higher layers. Such information may also include the associated QoS parameters per any of flow, PDU set, packet set, and packet granularities.

The AF/AS may send a message requesting the configuration of the QoS to the NEF/PCF and/or to the ProSe Application Server 608. For instance, a Nnef_AFsessionWithQoS Create Request message.

The PCF may be aware of the different network nodes, their capabilities, and the UE sidelink. The PCF may store information received from the PCE and may generate, for all or a subset of links (including sidelink and Uu), routing path computation rules, which are rules that allow a UE to derive paths (including Tracks and sub-Tracks), suitable per each flow. The PCF may generate rules for deriving QoS rules and profiles for flows sent over sidelink links. The PCF may generate PCC rules for PDU sessions associated with the same application. The PCF/PCE may perform an update of the UEs policies 609. The update may be done by sending Management UE Policy Command messages to the UEs, which are replied with Management UE Policy Complete messages from the UEs. These messages comprise the URSP rules or ProSe policies (ProSeP) rules for the UE(s), which are extended to include DetNet-augmented policies. The DetNet-augmented policies may comprise the support of message or packet duplication, message or packet merging, support of network coding, for extra reliability. Extensions may include, for example: Track IDs, PREOF/PAREO rules to apply to traffic, and network coding policies to apply to traffic. The NEF/PCF may respond back to the AF/AS with a Nnef_AFsessionWithQoS Notify message 610.

Based on the rules/policies received from the PCF and local information, which may be updated through additional OAM mechanisms, the UEs may configure both ProSe and DetNet communication links needed to satisfy the requirements of the application. This may be based on runtime conditions (e.g., direct link quality to other neighboring UEs) 611.

The UE(s) may determine per-packet forwarding decisions to ensure the QoS demanded by the service 612 based on the policies and associated rules. These decisions may include complex forwarding schema, such as duplication and merging or even network coding, adopting the DetNet mechanisms. This may require the use of DetNet data plane mechanisms (e.g., RFC 8939) or the extension of 3GPP data plane to include information that allows identifying DetNet flows. The UE(s) are playing the role of the PSE entity defined by the DetNet architecture.

If the multimodal communication includes functions hosted at the infrastructure (either at the mobile network edge/core or at an external data network), DetNet data plane mechanisms may be used to provide end-to-end reliable communications. This may include, as a non-limiting example, the use of IP data plane mechanisms (as specified in RFC 8939), extensions to other encapsulation mechanisms to include a service label (S-label).

The traffic is at this point exchanged between the different nodes according to the decisions of the PSE functionality running on the UEs. Non-limiting examples of packet forwarding decisions taken by the UEs include: dynamic selection of the path (Track) to use, based on local context information; duplication (by source and/or intermediate UEs) of the packet and transmission over multiple paths (Tracks); merging (by intermediate and/or destination UEs) of traffic received over multiple paths (Tracks); and application of network coding policy. Adequate monitoring tools should be in place to detect/predict potential disruptions in the agreed QoS and react as fast as possible.

While FIG. 6 illustrates a UE-triggered or UE-controlled approach, this is provided by way of example and is not limiting. For example, AFs at the network infrastructure may also trigger/control the procedures. Examples of messages that may be originated from an AF are shown in 602 and 604 in FIG. 6, and associated descriptions above.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit/receive unit (WTRU), the method comprising:
sending, to a network, WTRU capabilities including WTRU multimodal communication capabilities;
sending, to an Application Function (AF) associated with the network, multimodal application Quality of Service (QoS) requirements, wherein the QoS requirements include reliable and available wireless (RAW)-augmented parameters;
receiving, from the network, multimodal policy and configuration parameters associated with a multimodal operation;
establishing direct links with one or more WTRUs based on the received multimodal policy; and
determining, on a per-packet basis, which multimodal policy to apply to each packet and which communication link to use for sending each packet.

2. The method of claim 1, wherein the WTRU multimodal communication capabilities include one or more of:
Deterministic Networking (DetNet) associated functions hosted by the WTRU UE;
packet and protocol data unit (PDU) Set level routing capability;
information related to the multimodal applications supported comprising including one or more of: QS requirements, application modality types supported, or application identities supported;
time or durations when multimodal communication links may be needed; and
geographical locations where multimodal communication links may be needed.

3. The method of claim 1, wherein the WTRU multimodal communication capabilities include Internet Engineering Task Force (IETF) Deterministic Networking (DetNet) capabilities.

4. The method of claim 1, where the WTRU multimodal communication capabilities are sent in at least one of the Registration message or the 5GMM Capability Information Element (IE).

5. The method of claim 1, wherein the WTRU multimodal communication capabilities include comprise a request for network authorization for the WTRU to exercise the multimodal communication capabilities.

6. The method of claim 1, wherein the multimodal application QoS requirements include at least one of latency, reliability or availability.

7. The method of claim 1, wherein the multimodal QoS requirements include a time window during which the multimodal links are required to operate.

8. The method of claim 1, wherein the multimodal QoS requirements include geographical locations where the multimodal links are required to operate.

9. The method of claim 1, wherein the multimodal policy and configuration parameters include one or more of: a DetNet policy and configuration, including at least one of Track identification information; Packet Replication, Elimination, and Ordering Functions (PREOF) information; Packet (hybrid) ARQ, Replication, Elimination and Ordering (PAREO) information; or network coding policy information.

10. The method of claim 1, wherein the communication link to use for sending each packet includes comprises at least one of: a Proximity Service (ProSe) communication link, a DetNet communication link, or a direct communication link to the network.

11. A wireless transmit/receive unit (WTRU), the WTRU comprising:
a processor;
a communication interface;
the processor and the communication interface configured to send, to a network, WTRU capabilities including WTRU multimodal communication capabilities;
the processor and the communication interface configured to send, to an Application Function (AF) associated with the network, multimodal application Quality of Service (QoS) requirements, wherein the QoS requirements include reliable and available wireless (RAW)-augmented parameters;
the processor and the communication interface configured to receive, from the network, multimodal policy and configuration parameters associated with a multimodal operation;
the communication interface configured to establish direct links with one or more WTRUs based on the received multimodal policy; and
the processor configured to determine, on a per-packet basis, which multimodal policy to apply to each packet and which communication link to use for sending each packet.

12. The WTRU of claim 11, wherein the WTRU multimodal communication capabilities include one or more of:
Deterministic Networking (DetNet) associated functions hosted by the WTRU;
packet and protocol data unit (PDU) Set level routing capability;
information related to the multimodal applications supported including one or more of: QoS requirements, application modality types supported, or application identities supported;
time or durations when multimodal communication links may be needed; and
geographical locations where multimodal communication links may be needed.

13. The WTRU of claim 11, wherein the WTRU multimodal communication capabilities include Internet Engineering Task Force (IETF) Deterministic Networking (DetNet) capabilities.

14. The WTRU of claim 11, where the WTRU multimodal communication capabilities are sent in at least one of the Registration message or the 5GMM Capability Information Element (IE).

15. The WTRU of claim 11, wherein the WTRU multimodal communication capabilities include a request for network authorization for the WTRU to exercise the multimodal communication capabilities.

16. The WTRU of claim 11, wherein the multimodal application QoS requirements include at least one of latency, reliability or availability.

17. The WTRU of claim 11, wherein the multimodal QoS requirements include a time window during which the multimodal links are required to operate.

18. The WTRU of claim 11, wherein the multimodal QoS requirements include geographical locations where the multimodal links are required to operate.

19. The WTRU of claim 11, wherein the multimodal policy and configuration parameters include one or more of: a DetNet policy and configuration, including at least one of Track identification information; Packet Replication, Elimination, and Ordering Functions (PREOF) information; Packet (hybrid) ARQ, Replication, Elimination and Ordering (PAREO) information; or network coding policy information.

20. The WTRU of claim 11, wherein the communication link to use for sending each packet includes at least one of: a Proximity Service (ProSe) communication link, a DetNet communication link, or a direct communication link to the network.
